(19) United States
(12) Patent Application Publication
(10) Pub. No.: US 2003/0021401 A1
(43) Pub. Date: Jan. 30, 2003

(54) Method for signaling a connection set-up emanating from a calling terminal via a communications network to a called terminal

(76) Inventor: Bernhard Krembs, Gruenwald (DE)

Correspondence Address: MORRISON & FOERSTER LLP, 2000 PENNSYLVANIA AVE, NW, SUITE 5500, WASHINGTON, DC, 20006-1888, US

(21) Appl. No.: 10/168,702

(22) PCT Filed: Dec. 11, 2000
(86) PCT No.: PCT/DE00/04402

(30) Foreign Application Priority Data
Dec. 22, 1999 (DE) 199 62 174.8

(51) Int. Cl. H04M 3/42

(52) U.S. Cl. 379/207.02; 379/201.02

(57) ABSTRACT

Provided that at least one access connection which leads to a terminal (TLNB) of a called subscriber is engaged, a signaling, which indicates a connection set-up, to the called terminal is initiated by the originating exchange (VSTA).

Method for signaling connection setup emanating from a calling terminal via a communications network to a called terminal

The invention relates to a method for signaling connection setup emanating from a calling terminal via a communications network to a called terminal, in accordance with the precharacterizing clause of patent claim 1, where at least one access connection routed to the called terminal is busy.

In today's communications networks, such a method is known particularly in connection with the service feature “call waiting” or “call offer”. By way of example, the “call waiting” service feature is specified for an ISDN network in an ETSI standard ETS 300 058-1. Use of the “call waiting” service feature allows a called subscriber who is currently on a call with a calling subscriber in the communications network, which means that at least one access connection for his terminal is busy, to have other incoming calls signaled to him. This service feature presupposes that an exchange in the communications network, namely the destination exchange to which the terminal of the called subscriber is normally connected either directly or indirectly via a private branch exchange using a subscriber line, stores authorization for the called subscriber which allows him to use this service feature.

On the basis of the procedure described in the ETSI standard, the “call waiting” service feature involves interchanging the following messages between a calling subscriber and a called subscriber via the communications network:

First, the terminal of the called subscriber receives a “setup message”. This message signifies that there is an incoming call for said terminal. This message is used to provide all the information which the network is able to supply for terminal selection, compatibility checking and, if necessary, for authorization checking (e.g. service features, services). Only if all the access connections routed to the called subscriber's terminal are busy does the called subscriber first need to put a call or data connection into a “hold state” or to terminate said connection. Next, the calling subscriber's terminal is sent an alerting message from the destination exchange via the originating exchange, which notifies the terminal that the called terminal is in principle able to accept the call. When the incoming call has been accepted by the called subscriber, a connect message is used to signal to the calling subscriber that a user connection has been put through in the network.

A drawback of the procedure described is, in particular, that in cases in which no authorization for the “call waiting” service feature is stored for the called subscriber in the exchange, the calling subscriber is not able to signal his connection intent to the called subscriber's terminal while at least one access connection for the called terminal is busy.

A method is also already known (EP-A-0 822 697) which allows a called telephone subscriber to distinguish between calling subscriber stations. In this case, it is assumed that it is known practice in private branch exchanges (PBX) to display the internal call number of a calling subscriber station on the display panel of a called subscriber station in the private branch exchange in question. In this case, in connection with the public telephone network, it is assumed that a calling line identification service (CLID) is possible which allows the identity of a calling subscriber station to be displayed in the display panel of a terminal station in a called subscriber station.

Since the procedure just considered works only if calling line identification restriction by the respectively calling subscriber station is not possible, however, the known method for distinguishing between calling subscriber stations has provision for a password to be stored for a subscriber station which is to be called in the switching system and in which the calls from calling subscriber stations need to be able to be distinguished from one another. Calls for which this password or a corresponding pass code is used are dealt with in a special way. Upon a call to the relevant subscriber station which is to be called, said subscriber station is initially not sent a ringing signal if the relevant subscriber station to be called has activated a “do not disturb” service (DND); if, on the other hand, the relevant subscriber station to be called is free, a normal ringing signal is sent to it. In the former case, a busy signal is sent to the calling subscriber station even though the relevant subscriber station to be called is free, and in the second case a call-back signal is sent to it. Following the subsequent entry of the password or pass code in the relevant calling subscriber station, a special ringing signal is then sent to the called subscriber station in each case. This special ringing signal is different than normal ringing signals and thus indicates to the called subscriber station that the calling subscriber station is one from a selected group of calling subscriber stations to which the password in question is known.

In the case of the known procedure considered above, it is assumed that the respectively called subscriber station can actually accept all possible types of signaling and has also authorized acceptance thereof. This cannot always be assumed, however. Thus, called subscriber stations and terminals may not have set up or authorized the supply of signaling information and hence of signaling for the case in which at least one access connection for them is busy. In this case, the known procedural measure currently under consideration is of no use for notifying the respectively called subscriber station or terminal of signaling of connection setup emanating from a calling terminal when at least one access connection routed to it is busy.

In addition, a method and a circuit arrangement for providing telecommunications services for terminals in a communications network are known (U.S. Pat. No. 5,825,867). In this case, the application of signaling, the so-called “call waiting”, is assumed, inter alia, which involves signaling to a busy terminal which is to be called that another calling terminal wishes to set up a connection to the relevant terminal to be called. This thus presupposes, however, that such signaling is permitted for this terminal which is to be called, or reception thereof has been authorized by the relevant terminal to be called.

In the case of the known method just mentioned, to signal the urgency of a call to a terminal to be called when this terminal is busy, provision is made for an additional command to be input from the respectively calling terminal when it has been established that the relevant terminal to be called is busy, said additional command indicating the urgency of a waiting further call to the terminal which is to be called. Hence, it is also presupposed in this case, however, that such signaling is permitted for the respective terminal to be called in the communications network containing said terminal, or has been set up in the communications network from the relevant terminal to be called.

The object of the invention is thus to improve a signaling method of the type specified in the precharacterizing clause of the patent claim such that a terminal to be called or a called terminal for which at least one access connection routed thereto is thus busy can, in the event of this terminal not having set up any authorization for signaling which indicates another connection request, that is to say not wanting to receive this signaling per se, nevertheless be sent this signaling from particular calling terminals to the relevant terminal to be called or called terminal.

The invention achieves this object for a method of the type mentioned in the introduction in that, if there is no authorization for such signaling for the relevant called terminal, signaling which indicates said connection setup is prompted for the called terminal in the case of the calling terminal or is initiated by the originating exchange in the communications network, in that this originating exchange stores appropriate signaling authorization for the relevant calling terminal, and in that the calling terminal or the originating exchange has received a message indicating the busy condition of the at least one access connection routed to the called terminal.

The invention affords the advantage that the signaling of connection setup to the called terminal, where at least one access connection routed to this terminal is busy, no longer depends on authorization of the called terminal. Thus, initiation of the signaling, which indicates setup of the connection, to the called terminal can be initiated from the calling end, e.g. in the form of the “call waiting” service feature, even though this signaling has not been set up by or for the called terminal. This means that the relevant signaling can nevertheless be output to the respectively called terminal.

An exemplary embodiment of the invention is explained in more detail below with reference to a drawing, in which:

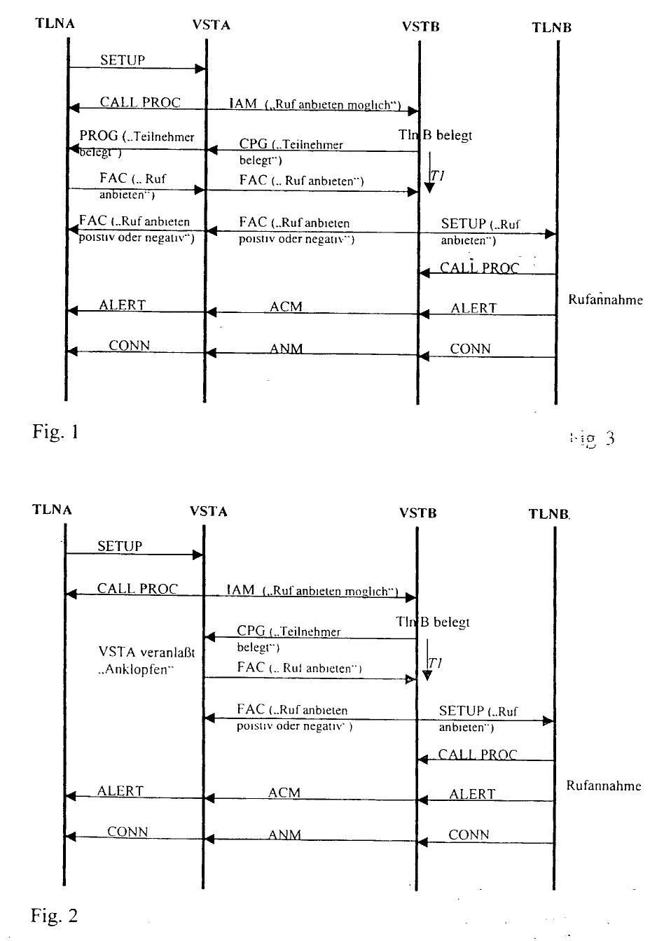

FIG. 1 shows a message sequence when the calling subscriber prompts “call waiting” explicitly when he has received signaling indicating that at least one access connection for the called subscriber's terminal is busy,

FIG. 2 shows a message sequence when the originating exchange initiates “call waiting” automatically on the basis of authorization of the calling subscriber when the originating exchange has been notified that at least one access connection for the called subscriber's terminal is busy,

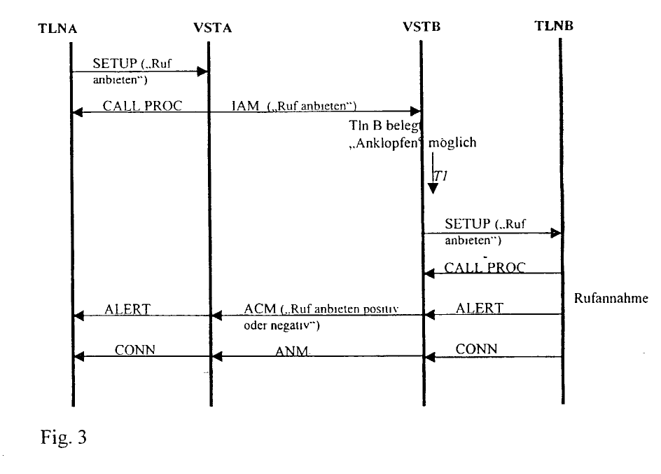

FIG. 3 shows a message sequence where “call waiting” is signaled to the called subscriber's terminal whenever a connection is set up, provided that at least one access connection for the called subscriber's terminal is busy.

In all three figures, the message sequence takes place between a terminal TLNA associated with the calling subscriber, an originating exchange, a destination exchange and a terminal TLNB associated with a called subscriber.

FIG. 1 describes the following exemplary sequence: The terminal TLNA initiates setup of a connection using the message SETUP, which is received by the originating exchange VSTA. The originating exchange VSTA sends a message CALL PROC back to the terminal TLNA, which signifies that the exchange requires no further dialing information for setting up the connection. In addition, the originating exchange VSTA sends a message IAM (Initial Address Message), containing an indicator, e.g. “offer call possible”, to the destination exchange VSTB. What are known as indicators or protocol discriminators are respectively set behind the message names in the figures. Provided that at least one access connection for the terminal TLNB is busy, the destination exchange establishes this and sends the originating exchange VSTA a message CPG (Call Progress Message) which contains an indicator, e.g. “subscriber busy”. The originating exchange VSTA forwards a message PROC containing the indicator e.g. “subscriber busy” to the terminal TLNA. When “subscriber busy” has been signaled to the calling subscriber's terminal TLNA, the subscriber has the option of prompting “call waiting”, e.g. by dialing a service number or by pressing a special key. In this case, the terminal TLNA sends the originating exchange VSTA a message FAC (Facility), which contains an indicator, e.g. “offer call”. The originating exchange VSTA forwards this message to the destination exchange VSTB. Between the sending of the message CPG and the arrival of the message FAC in the destination exchange VSTB, a particular time period T1 must not be exceeded, which is checked within the destination exchange VSTB using a timekeeper. The destination exchange VSTB confirms the previously received message FAC using a message FAC containing an indicator, e.g. “offer call possible positive or negative”, to the originating exchange VSTA, which forwards this confirmation to the terminal TLNA. In the case of positive confirmation, the destination exchange VSTB signals a connection setup message SETUP containing the indicator e.g. “offer call” to the terminal TLNB. The terminal TLNB returns a message CALL PROC to the destination exchange VSTB. When the incoming call has been signaled using the message SETUP (“offer call”), the called subscriber has the option of accepting the incoming call by putting existing call or data connections into a hold state, or at least initiating a call or data connection. The subscriber can also reject the incoming call indicated by means of the message SETUP (“offer call”).

If the called subscriber has accepted the signaled incoming call, the terminal TLNB sends a message ALERT to the destination exchange VSTB, which notifies the destination exchange VSTB that the terminal TLNB is in principle able to accept the call, and all compatibility checks and, if necessary, authorization checks by this terminal have had positive results. The destination exchange VSTB then sends an ACM (Address Complete Message) to the originating exchange VSTA. The originating exchange VSTA sends the terminal TLNA an ALERT message, which signifies that it has been possible to set up a connection to the destination on the network. In addition, the terminal TLNB sends the destination exchange VSTB a message CONN. The destination exchange VSTB forwards a message ANM (Answer Message) to the originating exchange VSTA, which in turn forwards a message CONN to the terminal TLNA. The last message chain provides notification that the incoming call has been accepted by the called terminal TLNB. Automatically answering terminals send a message CONN straight away instead of the message ALERT.

The message sequence described in FIG. 2 differs from the sequence described in FIG. 1 in the following steps:

When the message CPG containing the indicator e.g. “subscriber busy” has been sent to the originating exchange VSTA, the originating exchange VSTA checks whether the calling subscriber has authorization to signal “call waiting”. If the subscriber is authorized to do so, the originating exchange VSTA automatically sends the message FAC containing the indicator e.g. “offer call” to the destination exchange VSTB. The destination exchange VSTB confirms this message by returning the message FAC containing the indicator e.g. “offer call positive or negative” to the originating exchange VSTA. Finally, the destination exchange VSTB sends the message SETUP containing the indicator e.g. “offer call” to the terminal TLNB. The subsequent message sequence corresponds to the sequence already explained in FIG. 1.

In FIG. 3, the terminal TLNA sends a message SETUP already containing the indicator e.g. “offer call” to the originating exchange VSTA. The originating exchange VSTA sends a CALL PROC message back to the terminal and at the same time sends a message IAM containing the indicator e.g. “offer call” to the destination exchange VSTB. In this way, “call waiting” is desired by the calling subscriber together with setup of the connection. The destination exchange VSTB establishes whether at least one access connection for the terminal TLNB is busy. If this is the case, the destination exchange VSTB signals a message SETUP containing the indicator e.g. “offer call” to the terminal TLNB. The rest of the procedure corresponds essentially to the sequence outlined in FIG. 1 or 2. When the message ACM is sent from the destination exchange to the originating exchange, the message ACM additionally contains a confirmation indicator e.g. “offer call positive or negative”.

If the functions of the originating exchange VSTA and the functions of the destination exchange VSTB are combined in one exchange, the message sequence can be envisaged such that in FIGS. 1 to 3 the message sequence between the exchanges VSTA and VSTB does not take place. Thus, in this case, there would just remain a message sequence between a terminal TLNA, a single exchange, e.g. VSTA, and a terminal TLNB.

In addition, the inventive method is in no way limited to communications networks containing ISDN subscriber lines. Instead, corresponding message sequences can also be applied to communications networks containing analog subscriber lines or to communications networks which comprise both ISDN and analog subscriber lines.

Also, the terminals associated with a calling and called subscriber can be connected to the originating and destination terminals via a packet-switching communications network, e.g. the Internet.

1. A method for signaling connection setup emanating from a calling terminal (TLNA) via a communications network to a called terminal (TLNB), where at least one access connection routed to the called terminal is busy, characterized in that, if there is no authorization for such signaling for the relevant called terminal (TLNB), signaling which indicates said connection setup is prompted for the called terminal (TLNB) in the case of the calling terminal (TLNA) or is initiated by the originating exchange (vsta) in the communications network, in that this originating exchange (vsta) stores appropriate signaling authorization for the relevant calling terminal (TLNA), and in that the calling terminal (TLNA) or the originating exchange (VSTA) has received a message indicating the busy condition of the at least one access connection routed to the called terminal (TLNB).
